(19) United States
(12) Patent Application Publication
(10) Pub. No.: US 2014/0121702 A1
(43) Pub. Date: May 1, 2014

(54) METHOD AND DEVICE FOR BABY ORAL ACCESSORY PACIFIER AND BOTTLE

(71) Applicants: Shay Ezra, (US); Yishay Ashkenazy, (US); Maxim Yosef Gvili, (US); Eli Shomroni, (US)

(72) Inventors: Shay Ezra, Beer-Yakov (IL); Yishay Ashkenazy, Holon (IL); Maxim Yosef Gvili, Holon (IL); Eli Shomroni, Holon (IL)

(73) Assignees: SHAY EZRA, BEER-YAKOV (IL); ELI SHOMRONI, HOLON (IL); MAXIM YOSEF GVILI, HOLON (IL); YISHAY ASHKENAZY, HOLON (IL)

(21) Appl. No.: 13/662,741

(22) Filed: Oct. 29, 2012

(51) Int. Cl. A61J 17/00

(52) U.S. Cl. CPC A61J 17/00
USPC 606/234

(57) ABSTRACT

The present invention innovates in a labeled oral accessory such as pacifier and bottle for the purpose of indicating the baby's name or other desirable personal information on those elements according to this invention. The present invention is Method and device for an oral accessory such as pacifier and bottle consists or build in the following order: a nipple, nipple base or holder fastening for the nipple, a transparent closer attaching to and on to the nipple holder part or back base, a connecting members that enabling a connecting of letters or numbers to part or to the back part of the holder in a pacifier or to the nipple base or holder in bottle, to create the inventions object of connecting an identification element such as letters or numbers or forms or shapes to the accessories mentions.

### BACKGROUND OF THE INVENTION

The field of the present invention relates to oral accessory such as pacifier and bottle, as they functions as a baby's oral accessory.

Pacifiers and bottle are commodities for baby's care in the parenthood daily life. To avoid orally transmitted diseases, every baby has his own exclusive oral accessory. However, differentiations in models and colors of present oral accessory are rather too similar for distinguishing one item from another, especially for baby's who are usually not mature enough to distinctions one pacifier and bottle for example from another of their type, farther more when we dealing with multiple objects.

Therefore, the parents and the kindergarten are the ones to be responsible to guard and ensure not to mixed one baby pacifier or bottle in a community such as in a baby's day care center, kindergarten or just at home. If one uses someone else's pacifier for example for a personal use, one might get infected orally from the other one's bacterium's.

It is not reasonable to expect for example from kindergarten teacher that deals with tens of baby's, among all she has to take care of and to remembers the baby's entire pacifier belonging orders and marks.

Therefore, a pacifier or bottle, on which a name for example can be placed on, has been developed in the unique order of parts that given the invention the security needed in parts and the unique shape and design, wherein the opposed side of the pacifier nipple base for example, is designed as a surface fitting to holed several embodiments such as a personal names and information arranged by the baby's parents for example, from supplied letters, that enabling the parents for example to assemble the desired baby name or personal information. Connecting means for placing letters that forms the name written on it and a small transparent cover is used for sealing the opening thereof, creating kind of hollow section at the back side of the nipple base in the pacifier for example. Thus the pacifier for example achieves an identification purpose. This invention enabling other embodiments that will be specifies in the related sections. Nevertheless, the cover and the contact area of the cover are too be small and from minimum weight, so that the pacifier won't be a burden in the baby mouth.

### SUMMARY OF THE INVENTION

It is to be understood that both the foregoing general description and the following detailed description present embodiments of the invention and are intended to provide an overview or framework for understanding the nature and character of the invention as it is claimed.

The invention relates to an oral accessory such as pacifier and bottle capable of indicating personal information on the baby's pacifier and baby's bottle, and more particularly, to a labeled pacifier and bottle indicating personal information such as the baby's name. Displaying the name at the nipple base area of the pacifier for example, in the opposite side of the nipple it self, thereof uses a transparent cover and closure to cover the name but yet to make it visible to observe from the outside.

The labeled oral accessory such as the pacifier and bottle indicating the baby's name or other desirable personal information due to the elements according to this invention, consists or build in the following order: a nipple, nipple base or holder fastening for the nipple, a transparent closer attaching to and on to the nipple holder part or back base, a connecting members that enabling a connecting of letters or numbers to part or to the back part of the holder in a pacifier or to the nipple base or holder in bottle, to create the inventions object of connecting an identification element such as letters or numbers or forms or shapes to the accessories mentions. The letters or numbers or forms and shapes or combination of those members inserted into the nipple base opposite side of the nipple in the pacifier example is for the purpose of indicating the user's his name and other personal information that he is familiar with even though his early age as a childe, thereby clearly labeling information such as the user's name, combing with another information for use at time of need such as, blood type, age, at cetera are another goal of this invention.

### BRIEF DESCRIPTION OF THE DRAWINGS

The accompanying drawings are included to provide a further understanding of the invention and are incorporated into and constitute a part of this specification. The drawings illustrate various embodiments of the invention and, together with the description, serve to explain the principles and operations of the invention, by way of example only and not to limit the invention to these descriptions only.

The detailed descriptions and technical contents of the invention shall be illustrated with the accompanying drawings below.

FIG. 1 shows schematic view of the first embodiment of the base surface of the pacifier fitted to connect to its tracks letters or numbers to achieve the baby personal information according to the invention.

FIG. 2 shows schematic view of the second embodiment of the base surface of the pacifier fitted to connect to its depression a letters or numbers to achieve the baby personal information according to the invention.

FIG. 3 shows schematic view of the third embodiment of the base surface of the pacifier fitted to connect to its sticky surface letters or numbers to achieve the baby personal information according to the invention.

FIG. 4 shows schematic view of the pacifier including the base part as in FIG. 2, the nipple, and the transparent cover according to the present invention.

FIG. 5 shows schematic view of the pacifier including the base part, and the nipple from one side a it and the transparent cover from the other side according to the present invention.

FIG. 6 shows schematic view of the pacifier letters or numbers provided a letter and the connecting means of the letter to the pacifier base according to the present invention.

FIG. 7 shows schematic view of the pacifier including the base part, and the nipple from one side of it and the transparent cover from the other side, and in the cover part inside the hollowed part is the latter forming the baby name according to the present invention.

FIG. 8 shows schematic view of the baby bottle including the base part container, the nipple, the transparent cover, and the screwing closer according to the present invention.

FIG. 9 shows schematic view of the baby bottle upper part including the nipple, the transparent cover, and the screwing closer, and connecting means to the letters for example according to the present invention.

### DESCRIPTION OF THE PREFERRED EMBODIMENTS

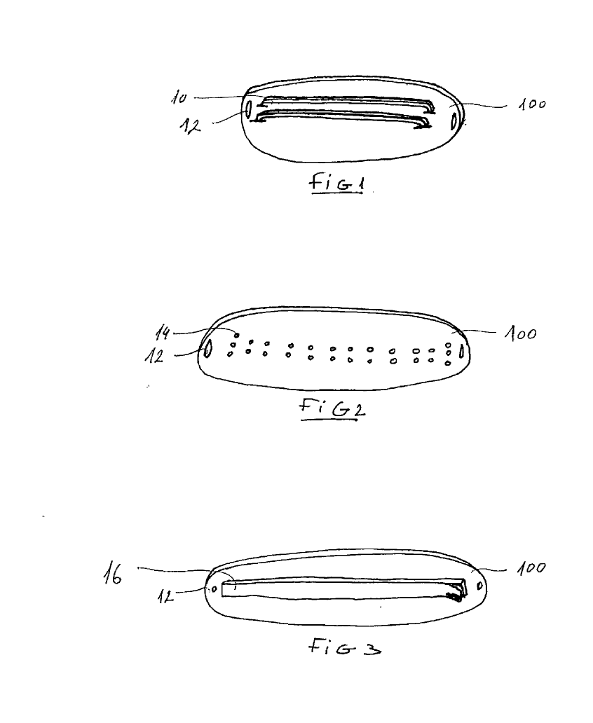

FIG. 1 shows schematic view of the first embodiment of the base surface 100 of the pacifier fitted to connect to it by connecting to tracks 10 letters or numbers to achieve the baby personal information elements according to the invention, respectively, the pacifier base surface 100 has on it a connecting means 12 to enabling the connection of the transparent cover to the existing back side pacifier cover of the pacifier base 100.

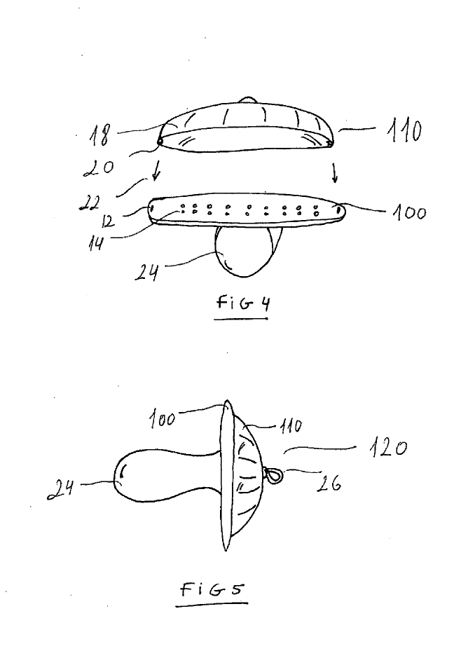

FIG. 2 shows schematic view of the second embodiment of the base surface 100 of the pacifier fitted to connect into its depression 14 a letters or numbers to achieve the baby personal information according to the invention. Also, the pacifier base surface 100 has on it connecting means 12 to enabling the connection of the back side pacifier transparent cover to the pacifier base 100.

FIG. 3 shows schematic view of the third embodiment of the base surface 100 of the pacifier fitted to connect to its sticky surface 16 letters or numbers to achieve the baby personal information according to the invention, such as the baby name.

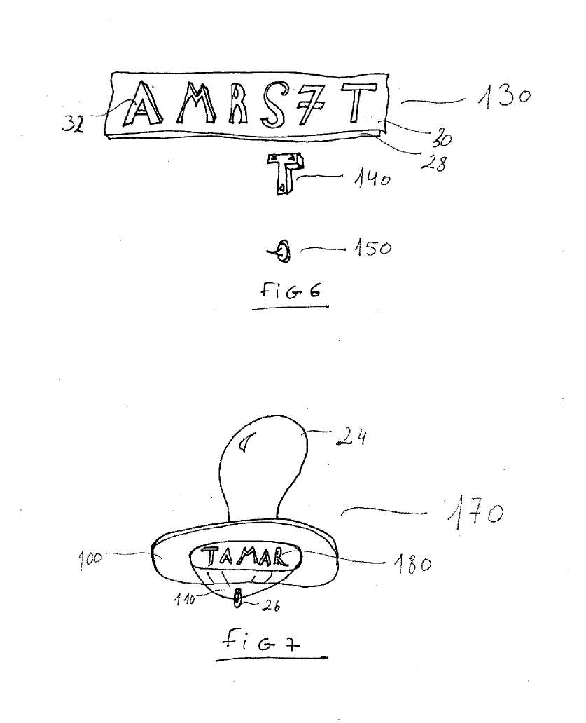

FIG. 4 shows schematic view of the pacifier including the base part 100 as in the embodiment mentioned in FIG. 2: depression 14 fitted to connect to the base 100 a latter for example, to achieve the baby personal information such as his name, the nipple 24 which is the part of the pacifier that the baby entering into his mouth, and the transparent cover 110 fitted to be connected by a connecting means 20 that are on the transparent 18 cover 110 to the base connecting means 12.

FIG. 5 shows the pacifier of the present invention viewed in FIG. 4, whereby, the parts shown at the schematic view of the pacifier 120 are connected to each other, including the base part 100, and the nipple 24 from one side of it and the transparent cover 110 connected to the base 100 from the other side, according to the present invention. At part of the cover 110 it is optional to connect a connecting means 26 for the purpose of connecting the pacifier to the baby clothing for example or to other means.

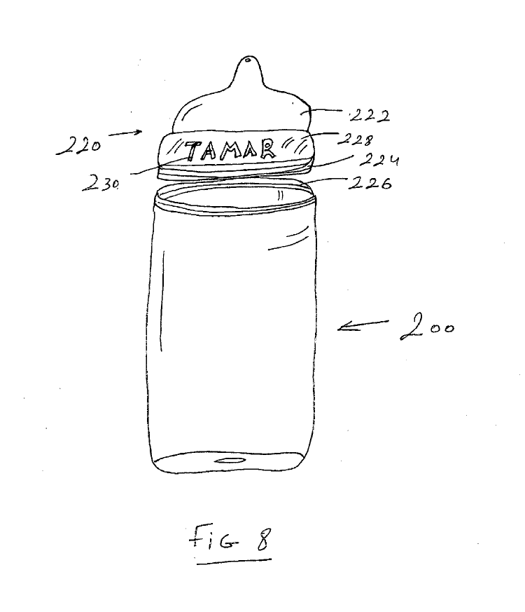

FIG. 6 shows schematic view of the pacifier letters or numbers pack or kit provided with the pacifier, to enable the user to achieve the invention purpose, to connect latter for example to the pacifier base 100 to assemble the baby name for example. A letter and the connecting means of the letter 150 for example fitted to be connected to the pacifier base depression 14 for example mentioned in FIG. 2 according to the present invention. The latter or the numbers, can forms a tree dimension shapes, however, it is riot category to that form, and the present invention includes another obvious embodiments such as 2 dimension letters, cards, lighting means as in addition to the part of the letters for example, etc.

FIG. 7 shows schematic view of the pacifier 170 of the present invention, including all the parts connected in the order of the present invention, forming the invention full purpose, including the base part 100, and the nipple 24 from one side of it and the transparent cover 110 from the other side, and in the cover part inside the hollowed part is the latter 180 forming the baby name “Tamar” for example, and the connecting ring 26 for example connected to lacing according to the present invention.

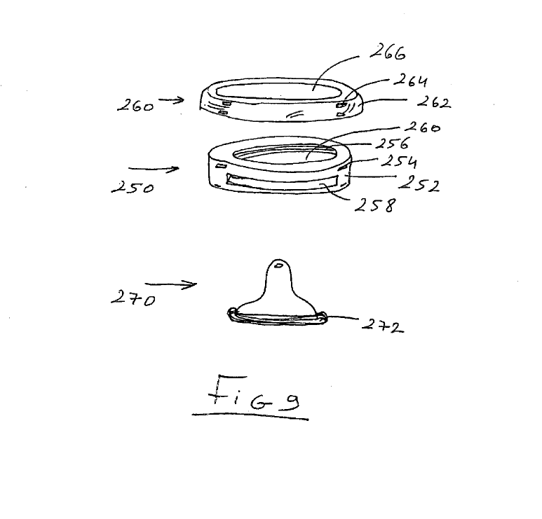

FIG. 8 shows another embodiment of the present invention formed at baby bottle, including the base part container 200, the nipple 222, the transparent cover 228 lies on the nipple fastening and screwing closer 224 that connected to 226 the base part 200 according to the present invention.

FIG. 9 shows schematic view of the baby bottle upper part including the nipple 270, the transparent cover 260, and the screwing closer 250, and connecting means 258 to the letters for example, whereby the elements 264 and 254 for example are connecting means to fastening part 262 on part 250 and by presser fastening base part 272 and the nipple 270 upper part going trough hole 266 whereby the screwing element 256 is the connected means to the container part according to the present invention.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A baby pacifier comprising a connecting means on the pacifier base opposite to the nipple; a letters or digits or forms with a connecting means fitted to be connected to the connecting means of the base; a transparent cover fitted to be connected to the base as a cover; wherein, observation from the outside of the cover to the hollow space closure enabling the observation of the information formed by the letters; information formed by the letter is writing regarding the baby s personal information on it

2. The labeled pacifier according to claim 1, wherein besides the letter option to form the baby's name or nickname, the inventions includes another optional parts that form another shape besides letters and it can be provides with numbers or another three or two dimensions forms or shapes.

3. The labeled pacifier according to claim 1, wherein the letter forming the baby's name or nickname, and the letter pack or kit provided with digits numbers or another forms and shapes too.

4. A baby pacifier comprising a connecting means on the pacifier base opposite to the nipple; a letters or digits or forms with a connecting means fitted to be connected to the connecting means of the base; a transparent cover fitted to be connected to the base as a cover; wherein, observation from the outside of the cover to the hollow space closure enabling the observation of the information formed by the letters or digits or forms; information formed by the letter is writing regarding the baby's personal information an it or an information that is in the baby ability to distinct from other forms or pacifiers and by this recognize his pacifier from another; wherein, the pacifier supplies with a letter or digits numbers or forms enabling the user to form his one baby information require on the pacifier and close the transparent cover on it.

5. A Method and device for Baby oral accessory of pacifier and bottle Comprising a labeled means consist at list one of those; a. letters; b. digits numbers; c. forms as for identifying the oral accessory by the baby from other oral accessory; for the purpose of indicating the baby's desirable personal information on those elements; wherein the method consists or builds in this order:
closer attaching to and on to the nipple holder part or back base, a connecting members enabling a connecting of letters or numbers or forms to part or to the back part of the holder in a pacifier or to the nipple base or holder in baby bottle, to create the inventions object of connecting an identification element such as letters or numbers or forms or shapes to the accessories mentions; when,
The letters or numbers or forms and shapes or combination of those members inserted into the nipple base opposite side of the nipple in the pacifier and on the upper part of the screwing closer of the bottle that presses the nipple, that for the purpose of indicating the user's his name and other personal information that he is familiar with even though his early age as a childe, when,
A transparent cover connected on to the back case of the pacifier or on to the bottle screwing closure still enabling the outside observer to view the letters or numbers or forms from the out side, and
thereby clearly more labeling information for the adult is an option such as the user's name, combing with another information for use at time of need such as, blood type, age, at cetera are another goal of this invention.
